(19) United States
(12) Patent Application Publication
(10) Pub. No.: US 2006/0254138 A1
(43) Pub. Date: Nov. 16, 2006

(54) Devices and methods for growing plants by measuring liquid or nutrient usage rate

(75) Inventors: W. Michael Bissonnette, Boulder, CO (US); John Thompson, Boulder, CO (US); Sylvia Bernstein, Boulder, CO (US); Laura L. Conley, Boulder, CO (US); Carson Payne, Niwot, CO (US); Robert E. Wainwright, Longmont, CO (US); Curt Morgan, Huntington Beach, CA (US)

Correspondence Address: AeroGrow International, Inc., Suite #201, 900 28th St., Boulder, CO, 80303, US

(73) Assignee: AeroGrow International, Inc., Boulder, CO (US)

(21) Appl. No.: 11/321,368

(22) Filed: Dec. 28, 2005

Related U.S. Application Data
(60) Provisional application No. 60/640,704, filed on Dec. 30, 2004.

(51) Int. Cl. A01G 31/00

(52) U.S. Cl. 47/60

(57) ABSTRACT

This invention provides Adaptive Growth Technology, smart garden devices for gardening systems, including hydroponics systems, and methods for modifying plant growth regimes based on the liquid usage rate and/or the nutrient usage rate of the plant. Characteristics of the plant growth regimes that are modified include: liquid delivery rate and/or quality, nutrient delivery rate and/or quality, add nutrient rate and/or quality, display or display rate of add nutrient quality and/or quantity, and/or photoradiation delivery rate and/or quality. This invention provides methods for making the devices of this invention and provides methods for using the devices of this invention. In an embodiment, the hydroponics system includes the smart garden device or the smart garden device fits in a chamber of the hydroponics device. In an embodiment, the steps are performed automatically without human intervention.

### CROSS-REFERENCE TO RELATED APPLICATIONS

This application claims priority under 35 U.S.C. 119(e) to provisional patent application No. 60/640,704, filed Dec. 30, 2004, which is hereby incorporated by reference in its entirety to the extent not inconsistent with the disclosure herein.

### FIELD OF THE INVENTION

This invention is in the fields of plant agriculture, home gardening, indoor gardening, and hydroponics.

### BACKGROUND

It is known in the art that plants use different quantities of water during different stages of growth. A plant's water use changes with a predictable pattern from germination to maturity (Soil, Water and Plant Characteristics Important to Irrigation, EB-66, February 1996, North Dakota State University Cooperative Extension Service). For example, plants use little water for germination and emergence, more water during vegetative growth, even more water during the reproductive growth stages, and less water again at maturity and senescence. Plants also use less water after cuttings.

In plant cultivation, the delivery rate of nutrients and water to the roots and the delivery rate of photoradiation to the shoots/flowers are known to impact the growth rate and health of the plant. For optimal growth, the delivery rates of nutrients, water, and photoradiation should vary as the plant grows. Adjusting the nutrient, water, and/or photoradiation as a function of plant growth allows an optimal environment to be created.

Knowledge of plant water use patterns during different growth stages have been used to influence irrigation system design and management. Soil moisture monitoring has been used for determining when to irrigate, determining how much irrigation water to apply, avoiding over- and under-irrigating, and correlating moisture/water use with vegetative growth (http://www.earthsystemssolutions.com/assets/monitoring.htm, Earth Systems Solutions, Lompoc, Calif. USA).

Various methods are known in the art for measuring water use by plants, including using irrigation/evaporation tubs and soil moisture probes and by monitoring the weight loss of intact plants grown in pots. “An electronic photometer for studying plant water use in real time” (PlantStress.com) describes a Micro-Electronic Potometer (MEP) for accurate real-time monitoring of plant water use. The instrument is described as being built from six units each comprising two parallel vessels joined by a tube; one vessel accommodating a hydroponically grown plant; the other containing a float connected to a high-accuracy linear variable differential transducer (LVDT).

Various methods are known in the art for predicting plant growth rates including light reflection and weather data. Spectroradiometers have been used to measure light reflected from plants to predict growth rates (Apogee Instruments Inc., Logan, Utah USA, http://www.stellarnet.us/agriculture.htm). Melon Man: A simple cantaloupe phenology model (USDA Agricultural Research Service) describes a project for developing methodologies using standard weather data to predict leaf appearance, crop developmental stages and final harvest date. The proposal describes plans for cantaloupe growers to use the model to accurately predict harvest dates as well as provide a tool for managing crop growth stage dependent applications of fertilizer, pesticides, and irrigation, allowing growers to make management decisions without visual inspection of crops.

Central control devices are useful in agriculture. U.S. Pat. No. 6,314,675 describes a method for managing an air culture system for plants using a central control unit. U.S. Pat. No. 5,525,505, U.S. Pat. No. 5,558,984, and U.S. Pat. No. 5,597,731 describe methods for controlling and regulating the flow and delivery of a liquid plant growth media automatically by a central control means including a microprocessor. These central control units receive data on the cultivation system, including temperature, humidity, and electrical conductivity (E.C.) of the nutrient solution. The content and delivery of the nutrient solution is described as then modified automatically by the central control unit.

No devices or methods for measuring and using measured water usage to determine or adjust the quantity and/or quality of nutrient and/or photoradiation delivery have been known in the art.

### SUMMARY OF THE INVENTION

This invention provides Adaptive Growth Technology, devices and methods for modifying plant growth regimes based on the liquid usage rate and/or the nutrient usage rate of the plant.

This invention provides smart garden devices for gardening systems comprising: means for measuring the quantity of liquid in the system and means for setting a characteristic of the system; the smart garden device comprising: means for receiving electricity; means for sending to and/or receiving data from the hydroponics system; means for measuring time elapsed; means for calculating liquid usage rate by the system; and means for modifying the characteristic of the system by utilizing the liquid usage rate.

This invention provides smart garden devices for gardening systems comprising: means for measuring the quantity of liquid in the system; and means for setting a characteristic of the system; means for measuring time elapsed; the smart garden device comprising: means for receiving electricity; means for sending to and/or receiving data from the hydroponics system; means for calculating liquid usage rate by the system; and means for modifying the characteristic of the system by utilizing the liquid usage rate.

This invention provides smart garden devices for hydroponics systems comprising: means for delivering a liquid to a plant or a seed germinating into a plant at a liquid delivery rate; and means for measuring the quantity of the liquid in the system; the smart garden device comprising: means for receiving electricity; means for sending to and/or receiving data from the hydroponics system; means for measuring time elapsed; means for calculating the liquid usage rate by the hydroponics system; and means for modifying the liquid delivery rate by a method utilizing the liquid usage rate.

This invention provides methods for making the devices of this invention and provides methods for using the devices of this invention.

In an embodiment, the hydroponics system further comprises: means for selecting a quality of liquid delivered to the plant; and the smart garden device further comprises: means for modifying the liquid delivery quality by a method utilizing the liquid usage rate. In an embodiment, the hydroponics system further comprises: means for displaying the status of a requirement to add at least one nutrient at a requirement to add nutrients rate; means for receiving nutrients; and means for delivering the nutrient to a plant at a nutrient delivery rate; and the smart garden device further comprises: means for modifying the nutrient delivery rate or the requirement to add nutrient rate, by a method utilizing the liquid usage rate. In an embodiment, the hydroponics system further comprises: means for displaying the quantity and/or quality of nutrients to add; and the smart garden device further comprises: means for modifying the display of the quantity and/or quality of nutrient to add by a method utilizing the liquid usage rate. In an embodiment, the hydroponics system further comprises: means for delivering photoradiation to the plant; and the smart garden device further comprises: means for modifying the photoradiation delivery rate by a method utilizing the liquid usage rate. In an embodiment, the hydroponics system further comprises: means for selecting quality of photoradiation delivered to the plant; the smart garden device further comprises: means for modifying the photoradiation delivered quality to the plant by a method utilizing the liquid usage rate. In an embodiment, the device comprises all of the above means.

In an embodiment, the hydroponics system comprises the smart garden device or the smart garden device fits in a chamber of the hydroponics device. This invention provides hydroponics systems comprising the smart garden devices of this invention.

In an embodiment, the liquid is an aqueous plant nutrient solution.

This invention provides methods for growing a plant comprising: providing the hydroponics system wherein the hydroponics system is growing a plant or germinating a plant from a seed and also providing the smart garden device, both can be any device of this invention; the method comprising: measuring a first quantity of liquid at a first time in the hydroponics system; allowing time to elapse; measuring a second quantity of liquid at a second time in the hydroponics system; measuring the time elapsed; calculating the liquid usage rate; and modifying one or more characteristic selected from the group consisting of: liquid quality, liquid delivery rate, plant nutrient quality, plant nutrient delivery rate, photoradiation quality, and photoradiation delivery rate, by a method utilizing the liquid usage rate.

This invention provides methods for growing a plant or germinating a seed into a plant comprising: providing the plant or the seed; providing a liquid having a liquid delivery quality; providing at least one plant nutrient having a plant nutrient quality; providing photoradiation having photoradiation quality; delivering the liquid to the plant at a liquid delivery rate; delivering the at least one plant nutrient at a plant nutrient delivery rate; delivering the photoradiation; measuring the liquid usage rate of the plant; modifying one or more characteristic selected from the group consisting of: liquid quality, liquid delivery rate, plant nutrient quality, plant nutrient delivery rate, photoradiation quality, and photoradiation delivery rate, by a method utilizing the liquid usage rate.

In an embodiment, the plant is germinated or the seed is grown within a hydroponics system. In an embodiment, measuring and modifying steps are performed automatically without human intervention.

This invention provides smart garden devices for a hydroponics system comprising: means for delivering a nutrient to a plant growing or a seed germinating into a plant in the hydroponics system at a nutrient delivery rate; and means for measuring the quantity of the nutrient in the system; and the smart garden device comprises: means for receiving electricity; means for sending to and/or receiving data from the hydroponics system; means for measuring time elapsed; means for calculating the nutrient usage rate by the hydroponics system; and means for modifying the nutrient delivery rate by a method utilizing the nutrient usage rate.

This invention provides methods for growing a plant or germinating a seed into a plant comprising: providing the plant or the seed; providing a liquid having a liquid delivery quality; providing at least one plant nutrient having a plant nutrient quality; providing photoradiation having photoradiation quality; providing a means for measuring the nutrient usage rate; delivering the liquid to the plant at a liquid delivery rate; delivering the at least one plant nutrient at a plant nutrient delivery rate; delivering the photoradiation; measuring the nutrient usage rate of the plant; and modifying one or more characteristic selected from the group consisting of: liquid quality, liquid delivery rate, plant nutrient quality, plant nutrient delivery rate, photoradiation quality, and photoradiation delivery rate, by a method utilizing the nutrient usage rate.

### DETAILED DESCRIPTION OF THE INVENTION

As used in the art and as used herein, “nutrients” refers to atoms and molecules in an available form necessary for plant growth in addition to oxygen, hydrogen, and water including, but not limited to, calcium, magnesium, sodium, potassium, nitrogen, phosphorus, sulfur, chlorine, iron, manganese, copper, zinc, boron, and molybdenum. Nutrient formulations and recipes are known in the art (see, for example, Resh H. M (2001) Hydroponic Food Production, Sixth Addition, Woodbridge Press Publishing Company, Santa Barbara, Calif., USA). As used in the art and as used herein, “grow” and “bloom” nutrients are complete sets of nutrients for vegetative and blooming/fruiting stages of plant development. Bloom nutrients are also useful for plants growing better with more nitrogen, magnesium, sulfate, and calcium, such as herbs, particularly basil.

It is known in the art that a liquid that contacts a plant, e.g., liquid used to supply nutrients to a plant, is preferably within a particular pH range. Optimal pH ranges for a variety of plants are known in the art. Preferably the compositions and methods of this invention maintain the pH of liquids within the optimal pH ranges.

As used herein, “photoradiation” refers to wavelengths of light of sufficient quantity and quality that allow a plant to grow, as is known in the art. It is known in the art which quantities and wavelengths of photoradiation are preferred for many plants.

Hydroponics systems in which liquid level can be measured and/or in which liquid usage rate can be measured are useful in the practice of this invention.

Water usage is an important indicator of plant growth, health, nutrient, and light requirements, therefore it is desirable to track water usage in order to determine how to best deliver nutrients, liquid, and/or photoradiation to the plant.

This invention provides Adaptive Growth Technology, devices and methods for modifying plant growth regimes based on the liquid usage rate and/or the nutrient usage rate of the plant. Adaptive Growth Technology provided by this invention is useful for optimizing and improving plant growth, speeding growth and increasing yields, compared to not using adaptive growth technology.

This invention provides smart garden devices for gardening systems comprising: means for measuring the quantity of liquid in the system; and means for setting a characteristic of the system; the smart garden device comprising: means for receiving electricity; means for sending to and/or receiving data from the hydroponics system; means for measuring time elapsed; means for calculating liquid usage rate by the system; and means for modifying the characteristic of the system by utilizing the liquid usage rate.

This invention provides smart garden devices for gardening systems comprising: means for measuring the quantity of liquid in the system; and means for setting a characteristic of the system; means for measuring time elapsed; the smart garden device comprising: means for receiving electricity; means for sending to and/or receiving data from the hydroponics system; means for calculating liquid usage rate by the system; and means for modifying the characteristic of the system by utilizing the liquid usage rate.

The means for measuring time elapsed an/or the means for measuring the quantity of liquid in the system can be part of the hydroponics system or part of the smart garden device.

This invention provides smart garden devices for hydroponics systems comprising: means for delivering a liquid to a plant or a seed germinating into a plant at a liquid delivery rate; and means for measuring the quantity of the liquid in the system; the smart garden device comprising: means for receiving electricity; means for sending to and/or receiving data from the hydroponics system; means for measuring time elapsed; means for calculating the liquid usage rate by the hydroponics system; and means for modifying the liquid delivery rate by a method utilizing the liquid usage rate.

This invention provides methods for making the devices of this invention and provides methods for using the devices of this invention.

In an embodiment, the hydroponics system further comprises: means for selecting a quality of liquid delivered to the plant; and the smart garden device further comprises: means for modifying the liquid delivery quality by a method utilizing the liquid usage rate.

In an embodiment, the hydroponics system further comprises: means for displaying the status of a requirement to add at least one nutrient at a requirement to add nutrients rate; means for receiving nutrients; and means for delivering the nutrient to a plant at a nutrient delivery rate; and the smart garden device further comprises: means for modifying the nutrient delivery rate or the requirement to add nutrient rate, by a method utilizing the liquid usage rate.

In an embodiment, the hydroponics system further comprises: means for displaying the quantity and/or quality of nutrients to add; and the smart garden device further comprises: means for modifying the display of the quantity and/or quality of nutrient to add by a method utilizing the liquid usage rate. In an embodiment, the system further comprises a means for displaying the quantity and/or quality of nutrients to add at a display rate; and the smart garden device further comprises a means for modifying the display rate by a method utilizing the liquid usage rate.

In an embodiment, the hydroponics system further comprises: means for delivering photoradiation to the plant; and the smart garden device further comprises: means for modifying the photoradiation delivery rate by a method utilizing the liquid usage rate.

In an embodiment, the hydroponics system further comprises: means for selecting quality of photoradiation delivered to the plant; the smart garden device further comprises: means for modifying the photoradiation delivered quality to the plant by a method utilizing the liquid usage rate.

In an embodiment, the device comprises all of the above means. In an embodiment, modifying is increasing or decreasing. In an embodiment, the smart garden device further comprises a means for comparing a first liquid usage rate to a second liquid usage rate.

In an embodiment, the means for measuring the quantity of liquid in the system comprises a device is selected from the group consisting of: floatation devices, magnetic read switch devices, electric current devices, proximity switch devices, infrared devices, sonic devices, hall effect sensor devices, photocell devices, and photographic devices.

In an embodiment, calculating the liquid usage rate comprises: measuring a first quantity of liquid in the system at a first time; measuring a second quantity of liquid in the system at a second time wherein the second time is before additional liquid is added to the system; subtracting the second quantity of liquid from the first quantity of liquid, and then dividing by the time elapsed between the first time and the second time.

In an embodiment, the means for measuring the quantity of the liquid in the system comprises a magnetic floatation device and a magnetic read switch. In an embodiment, the smart garden device comprises three magnetic floatation devices and three magnetic read switches.

In an embodiment, the hydroponics device comprises a means for maximally containing between about 14 cups and about 17 cups of liquid, wherein the first magnetic read switch is activated by the first magnetic floatation device when the hydroponics system contains between about 10 cups to about the maximum liquid level, wherein the second magnetic read switch is activated by the second magnetic floatation device when the hydroponics system contains between about 7 cups and about 10 cups, and wherein the third magnetic read switch is activated by the third magnetic floatation device when the hydroponics system contains less than about 7 cups. In an embodiment, the hydroponics device comprises a means for maximally containing an Amount A of liquid and a means for detecting when the device contains about Amount A of liquid and a means for detecting when the garden contains a selected portion of Amount A, such as about ⅔ of Amount A. In an embodiment, the hydroponics device comprises a means for maximally containing an amount B of liquid, wherein the first magnetic read switch is activated by the first magnetic floatation device when the hydroponics system contains between about ⅔ Amount B to about the maximum liquid level (Amount B), wherein the second magnetic read switch is activated by the second magnetic floatation device when the hydroponics system contains between about ½ Amount B and about ⅔ Amount B, and wherein the third magnetic read switch is activated by the third magnetic floatation device when the hydroponics system contains less than about ½ B. Other amounts, in addition to ½ B, ⅔ B, and B, are useful in the practice of this invention.

In an embodiment, this invention provides a smart garden device wherein said means for measuring the quantity of said liquid in said system comprises three magnetic floatation devices and three magnetic read switches, wherein said hydroponics device comprises a means for containing a maximum amount of liquid, wherein said first magnetic read switch is activated by said first magnetic floatation device when said hydroponics system contains between a larger liquid fraction and about the maximum amount of liquid, wherein said second magnetic read switch is activated by said second magnetic floatation device when said hydroponics system contains between a smaller liquid fraction and about the larger liquid fraction, and wherein said third magnetic read switch is activated by said third magnetic floatation device when said hydroponics system contains less than about said smaller liquid fraction. The larger amount and smaller amount are fractions of the maximum amount, and the smaller amount is less than the larger amount. The larger amount can be any selected measurable amount that is less than the maximum amount of liquid, and the smaller amount can be any selected measurable amount that is less than the larger amount. In an embodiment, the larger amount is between about half the maximum amount and the maximum amount and the smaller amount is between about 5% of the maximum amount and about half the maximum amount.

In an embodiment, the first time is about when the second read switch is activated which is about when the first read switch is deactivated or about when the first read switch is deactivated and the second time is about when the third read switch is activated or about when the second switch is deactivated which is about when the third read switch is activated.

In an embodiment, the first time is about when the third read switch is deactivated or when the second read switch is activated which is about when the third read switch is deactivated and the second time is about when the third read switch is secondly activated or about when the second read switch is activated which is about when the third read switch is deactivated.

In an embodiment, the liquid usage rate is first greater than about 3 cups per about 7 days, when the liquid delivery rate is increased. In an embodiment, the liquid usage rate is first greater than about 3 cups per 3 days, when the increased liquid delivery rate is secondly increased. In an embodiment, the liquid usage rate is first greater than about 3 cups per 1.5 days, when the further increased liquid delivery rate is thirdly increased.

In an embodiment, in any device of this invention, when the liquid usage rate is first greater than a rate selected from the group consisting of: about 3 cups per about 7 days, about 3 cups per about 3 days, about 3 cups per about 1.5 days, and about 3 cups per about ½ a day, a characteristic selected from the group consisting of: liquid delivery rate, liquid delivery quality, nutrient delivery rate, requirement to add nutrients rate, display of the quantity and/or quality of nutrients to add, photoradiation delivery rate, and photoradiation delivery quality, is modified.

In an embodiment, the smart garden device further comprises a means for sending data to or receiving data from an external preprogrammed or a programmable storage device directly or through the internet. In an embodiment, the smart garden device further comprises a device selected from the set consisting of: preprogrammed storage devices, programmable storage devices, circuit boards, and computer chips. In an embodiment, the smart garden device further comprises means for determining, receiving, sending, storing, and/or processing data. In an embodiment, the smart garden device further comprises a means for storing liquid usage rate data.

In an embodiment, the hydroponics system comprises the smart garden device or the smart garden device fits in a chamber of the hydroponics device. This invention provides hydroponics systems comprising the smart garden devices of this invention.

In an embodiment, the liquid is an aqueous plant nutrient solution.

In an embodiment, the hydroponics system further comprises a pump for delivering the liquid and modifying the liquid delivery rate comprises modifying the pump on/off frequency or modifying the pump flow rate while on.

This invention provides methods for growing a plant comprising: providing the hydroponics system wherein the hydroponics system is growing a plant or germinating a plant from a seed and also providing the smart garden device, both of any device of this invention; measuring a first quantity of liquid at a first time in the hydroponics system; allowing time to elapse; measuring a second quantity of liquid at a second time in the hydroponics system; measuring the time elapsed; calculating the liquid usage rate; and modifying one or more characteristic selected from the group consisting of: liquid quality, liquid delivery rate, plant nutrient quality, plant nutrient delivery rate, photoradiation quality, and photoradiation delivery rate, by a method utilizing the liquid usage rate.

This invention provides methods for growing a plant or germinating a seed into a plant comprising: providing the plant or the seed; providing a liquid having a liquid delivery quality; providing at least one plant nutrient having a plant nutrient quality; providing photoradiation having photoradiation quality; delivering the liquid to the plant at a liquid delivery rate; delivering the at least one plant nutrient at a plant nutrient delivery rate; delivering the photoradiation; measuring the liquid usage rate of the plant; modifying one or more characteristic selected from the group consisting of: liquid quality, liquid delivery rate, plant nutrient quality, plant nutrient delivery rate, photoradiation quality, and photoradiation delivery rate, by a method utilizing the liquid usage rate.

In an embodiment, the plant is germinated or the seed is grown within a hydroponics system.

In an embodiment, measuring the liquid usage rate comprises: providing a means for measuring the quantity of the liquid in the system; providing a means for measuring time elapsed; measuring a first quantity of liquid in the system at a first time; measuring a second quantity of liquid in the system at a second time wherein the second time is before additional liquid is added to the system; and subtracting the second quantity of liquid from the first quantity of liquid, and then dividing by the time elapsed between the first time and the second time.

In an embodiment, measuring and modifying steps are performed automatically without human intervention.

This invention provides smart garden devices for a hydroponics system comprises: means for delivering a nutrient to a plant growing or a seed germinating into a plant in the hydroponics system at a nutrient delivery rate; and means for measuring the quantity of the nutrient in the system; and the smart garden device comprises: means for receiving electricity; means for sending to and/or receiving data from the hydroponics system; means for measuring time elapsed; means for calculating the nutrient usage rate by the hydroponics system; and means for modifying the nutrient delivery rate by a method utilizing the nutrient usage rate.

In an embodiment, the smart garden device for a hydroponics system further comprises one or more means selected from the group consisting of: means for delivering a liquid quality to the plant or seed at a liquid delivery rate; and means for delivering a photoradiation quality to the plant or seed at a photoradiation delivery rate; and the smart garden device further comprises one or more paired means selected from the group consisting of: means for modifying the liquid delivery rate or liquid quality by a method utilizing the nutrient usage rate; and means for modifying the photoradiation delivery rate or photoradiation quality by a method utilizing the nutrient usage rate. The means are preferably paired such that the means required in the system are selected as required for the means selected the device or vice versa.

This invention provides methods for growing a plant or germinating a seed into a plant comprising: providing the plant or the seed; providing a liquid having a liquid delivery quality; providing at least one plant nutrient having a plant nutrient quality; providing photoradiation having photoradiation quality; providing a means for measuring the nutrient usage rate; delivering the liquid to the plant at a liquid delivery rate; delivering the at least one plant nutrient at a plant nutrient delivery rate; delivering the photoradiation; measuring the nutrient usage rate of the plant; and modifying one or more characteristic selected from the group consisting of: liquid quality, liquid delivery rate, plant nutrient quality, plant nutrient delivery rate, photoradiation quality, and photoradiation delivery rate, by a method utilizing the nutrient usage rate.

In an embodiment, the measuring and modifying steps are performed automatically without human intervention. In an embodiment, the nutrient is dissolved in the liquid wherein the nutrient usage rate is the change in nutrient concentration in the liquid over time. In an embodiment, the change in nutrient concentration is measured by the change in electrical conductivity of the liquid over time. Preferably, a measurement of the rate of water usage is made constantly and automatically, without the need for human intervention each time that a measurement is taken and an adjustment is made.

Water usage can be measured by any method known in the art or as yet to be invented. Methods for automatically measuring water level include, but are not limited to, indirect methods using floats to trigger a magnetic read switch (pulls magnets together), a proximity switch (blocking magnetic field), or a Hall-effect sensor (senses magnetic field and generates proportional signal), and direct methods using electrodes (detect current at water levels).

The embodiments of this invention are useful with both the devices and methods of this invention.

In an embodiment of this invention, the liquid usage rate of the nutrient usage rate correlates with and is predictive of the plant health, plant age, developmental stage, and/or maturity. In an embodiment, the devices and methods of this invention comprise means for measuring the temperature and humidity in which the plant is grown and utilizing these data to determine the appropriate liquid usage rate thresholds.

Optimum liquid usage rate thresholds and nutrient usage rate thresholds and liquid, nutrient, and photoradiation delivery regimes can be determined experimentally and utilized with the devices and methods of this invention.

In an embodiment, the device is preprogrammed with data regarding the typical liquid usage rate and/or nutrient usage rate for the type of plant to be grown.

The liquid usage rate for each plant type is affected by the type of plant growing system used and by the number of plants grown simultaneously.

In an embodiment, the characteristics of the device are modified utilizing data on both the liquid usage rate and the nutrient usage rate.

Plants grown using devices and methods of this invention are more healthy and productive than plants grown equivalently without using the methods and devices of this invention.

In an embodiment, the device is able to grow healthy, productive plants if the liquid usage rate and/or nutrient usage rate reach does not reach a minimum threshold for modifying a listed characteristic of the plant growing system.

In an embodiment, the device is also able to grow healthy, productive plants if the liquid usage rate is not measurable. For example, the liquid usage rate would might not be measurable if the liquid is delivered to the system by an external reservoir that adds a small amount of liquid to the system automatically when the third magnetic read switch is activated whereby enough water is added to deactivate the third magnetic read switch and active the second magnetic read switch, but not enough to activate the first magnetic read switch.

In an embodiment, a modification of the nutrient quality is a switch from grow nutrients to bloom nutrients, or an increase in the requirement to add nutrient rate of grow nutrients. Appropriate nutrient formulations and concentrations for selected plants and plant developmental stages are known in the art.

In an embodiment, modifying photoradiation quality comprises modifying the wavelengths of photoradiation delivered. In an embodiment, modifying photoradiation quality includes modifying the number of hours per day photoradiation is delivered and/or modifying the intensity of photoradiation delivered.

In an embodiment, the means for measuring the quantity of said liquid in the hydroponics system is in the smart garden device instead of the hydroponics system.

This invention provides a kit comprising a device of this invention and instructions for using the device.

### EXAMPLE 1

Tomatoes are grown using the methods and devices of this invention. During germination and seedling growth, liquid comprising water and grow nutrients is delivered for half and hour and then not delivered for half an hour, repeatedly, grow nutrients are only added once at the beginning, and photoradiation is delivered for about 14 hours and then not for about 10 hours, repeatedly. After a liquid usage rate threshold is achieved, at about 2 weeks, liquid comprising water and bloom nutrients is delivered for about 45 minutes and then not for about 15 minutes, repeatedly, bloom nutrients are added about every 6-8 days, and photoradiation is delivered for about 16 hours and then not for about 8 hours, repeatedly. After a second liquid rate threshold is achieved, at about 4 weeks, liquid comprising water and bloom nutrients is delivered about constantly, bloom nutrients are added about every 6-8 days, and photoradiation is delivered for about 18 hours and then not for about 6 hours, repeatedly. The tomato plants grown using these methods produce more tomatoes, more quickly, and that are more tasty, than control tomatoes grown with grow and then bloom nutrients that are switched according to a similar (but not equivalent) predetermined schedule, and with liquid and photoradiation delivery that are also delivered according to a similar (but not equivalent) predetermined schedule. The control tomatoes are not grown using an equivalent scheme because it is precisely the devices and methods of this invention that allow the regimes to be exactly tailored to the individual plants needs, optimizing liquid, nutrient, and photoradiation delivery at all times.

Although this invention has been described with respect to specific embodiments, it is not intended to be limited thereto, and various modifications which will become apparent to the person of ordinary skill in the art are intended to fall within the scope of the invention as described herein. The embodiments of this invention are useful individually and in combination.

All references cited are incorporated herein by reference to the extent that they are not inconsistent with the disclosure herein.

1. A smart garden device for a gardening system comprising:
means for measuring the quantity of liquid in said system; and
means for setting a characteristic of said system;
said smart garden device comprising:
means for measuring time elapsed;
means for receiving electricity;
means for sending to and/or receiving data from said gardening system;
means for calculating liquid usage rate by said gardening system; and
means for modifying said characteristic of said system by utilizing said liquid usage rate.

2. The smart garden device of claim 1 wherein said liquid is an aqueous plant nutrient solution.

3. The smart garden device of claim 1 wherein said gardening system is a hydroponics system, wherein said hydroponics system comprises:
means for delivering said liquid to a plant or a seed germinating into a plant at a liquid delivery rate; and
means for setting the liquid delivery rate; and
wherein said smart garden device comprises:
means for sending to and/or receiving data from said hydroponics system;
means for calculating the liquid usage rate by said hydroponics system; and
means for modifying the liquid delivery rate by a method utilizing said liquid usage rate.

4. The smart garden device of claim 1, said hydroponics system further comprising:
means for displaying the status of a requirement to add at least one nutrient at a requirement to add nutrients rate;
means for receiving nutrients; and
means for delivering said nutrient to a plant at a nutrient delivery rate; and
said smart garden device further comprising:
means for modifying the nutrient delivery rate or the requirement to add nutrient rate, by a method utilizing said liquid usage rate.

5. The smart garden device of claim 1, said hydroponics system further comprising:
means for displaying the quantity and/or quality of nutrients to add; and
said smart garden device further comprising:
means for modifying the display of the quantity and/or quality of nutrient to add by a method utilizing said liquid usage rate.

6. The smart garden device of claim 1 wherein modifying is increasing or decreasing.

7. The smart garden device of claim 1 further comprising a means for comparing a first liquid usage rate to a second liquid usage rate.

8. The smart garden device of claim 1 wherein calculating said liquid usage rate comprises:
a. measuring a first quantity of liquid in said system at a first time;
b. measuring a second quantity of liquid in said system at a second time wherein said second time is before additional liquid is added to said system;
c. subtracting said second quantity of liquid from said first quantity of liquid, and then dividing by the time elapsed between said first time and said second time.

9. The smart garden device of claim 8 wherein said means for measuring the quantity of said liquid in said system comprises three magnetic floatation devices and three magnetic read switches, wherein said hydroponics device comprises a means for containing a maximum amount of liquid, wherein said first magnetic read switch is activated by said first magnetic floatation device when said hydroponics system contains between a larger liquid fraction and about the maximum amount of liquid, wherein said second magnetic read switch is activated by said second magnetic floatation device when said hydroponics system contains between a smaller liquid fraction and about the larger liquid fraction, and wherein said third magnetic read switch is activated by said third magnetic floatation device when said hydroponics system contains less than about said smaller liquid fraction.

10. The smart garden device of claim 9 wherein
said first time is about when said second read switch is activated which is about when said first read switch is deactivated or about when said first read switch is deactivated and said second time is about when said third read switch is activated or about when said second switch is deactivated which is about when said third read switch is activated;
or wherein
said first time is about when said third read switch is deactivated or when said second read switch is activated which is about when said third read switch is deactivated and said second time is about when said third read switch is secondly activated or about when said second read switch is activated which is about when said third read switch is deactivated.

11. The smart garden device of claim 1 wherein when said liquid usage rate is first greater than about 3 cups per about 7 days, said liquid delivery rate is increased; wherein when said liquid usage rate is first greater than about 3 cups per 3 days, said increased liquid delivery rate is secondly increased; and wherein when said liquid usage rate is first greater than about 3 cups per 1.5 days, said further increased liquid delivery rate is thirdly increased.

12. The smart garden device of any of claim 1 wherein said characteristic is selected from the group consisting of: liquid delivery rate, liquid delivery quality, nutrient delivery rate, requirement to add nutrients rate, display of the quantity and/or quality of nutrients to add, photoradiation delivery rate, and photoradiation delivery quality.

13. The smart garden device of claim 1 further comprising means for determining, receiving, sending, storing, and/or processing data.

14. The smart garden device of claim 1 further comprising a means for storing liquid usage rate data.

15. A hydroponics system comprising said smart garden device of claim 1.

16. The smart garden device of claim 1 wherein said hydroponics system further comprises a pump for delivering said liquid and modifying the liquid delivery rate comprises modifying the pump on/off frequency or modifying the pump flow rate while on.

17. A method for growing a plant or germinating a seed into a plant comprising:
a. providing said plant or said seed;
b. providing a liquid having a liquid delivery quality;
c. providing at least one plant nutrient having a plant nutrient quality;
d. providing photoradiation having a photoradiation quality;
e. delivering said liquid to said plant at a liquid delivery rate;
f. delivering said at least one plant nutrient at a plant nutrient delivery rate;
g. delivering said photoradiation;
h. measuring the liquid usage rate of said plant;
i. modifying one or more characteristic selected from the group consisting of: liquid quality, liquid delivery rate, plant nutrient quality, plant nutrient delivery rate, photoradiation quality, and photoradiation delivery rate, by a method utilizing said liquid usage rate.

18. The method of claim 17 wherein said measuring the liquid usage rate comprises:
a. providing a means for measuring the quantity of said liquid in said system;
b. providing a means for measuring time elapsed;
c. measuring a first quantity of liquid in said system at a first time;
d. measuring a second quantity of liquid in said system at a second time wherein said second time is before additional liquid is added to said system; and
e. subtracting said second quantity of liquid from said first quantity of liquid, and then dividing by the time elapsed between said first time and said second time.

19. The method of claim 17 wherein said measuring and modifying steps are performed automatically without human intervention.

20. A smart garden device for a hydroponics system, said smart garden device comprising:
means for sending to and/or receiving data from said hydroponics system;
means for measuring time elapsed; and
means for determining the liquid usage rate by said hydroponics system;
and said system and/or device further comprising a set of means selected from the group consisting of:
a. means for delivering a liquid to a plant or a seed germinating into a plant at a liquid delivery rate and means for modifying the liquid delivery rate by a method utilizing said liquid usage rate;
b. means for selecting a quality of liquid delivered to said plant and means for modifying said liquid delivery quality by a method utilizing said liquid usage rate
c. means for displaying the status of a requirement to add at least one nutrient at a requirement to add nutrients rate, means for receiving nutrients, and means for delivering said nutrient to a plant at a nutrient delivery rate; means for modifying the nutrient delivery rate or the requirement to add nutrient rate, by a method utilizing said liquid usage rate;
d. means for displaying the quantity and/or quality of nutrients to add and means for modifying the display of the quantity and/or quality of nutrient to add by a method utilizing said liquid usage rate.
e. means for delivering photoradiation to said plant and means for modifying the photoradiation delivery rate by a method utilizing said liquid usage rate; and
f. means for selecting quality of photoradiation delivered to said plant and means for modifying the photoradiation delivered quality to said plant by a method utilizing said liquid usage rate.
